(19) United States
(12) Patent Application Publication
(10) Pub. No.: US 2011/0309310 A1
(43) Pub. Date: Dec. 22, 2011

(54) ELECTRODE-ACTIVE MATERIAL FOR ELECTROCHEMICAL ELEMENTS

(75) Inventors: Stefan Koller, Graz (AT); Stefan Pichler, Passail (AT); Bernd Fuchsbichler, Karpfenberg (AT); Frank Uhlig, Graz (AT); Calin Wurm, Ellwangen (DE); Thomas Wöhrle, Stuttgart (DE); Martin Winter, Münster (DE)

(73) Assignees: VOLKSWAGEN VARTA MICROBATTERY FORSCHUNGSGESELLSCHAFT MBH & CO. KG, ELLWANGEN (DE); VARTA MICROBATTERY GMBH, Hannover (DE)

(21) Appl. No.: 13/132,213

(22) PCT Filed: Dec. 4, 2009
(86) PCT No.: PCT/EP09/08673

§ 371 Date: Aug. 15, 2011

(30) Foreign Application Priority Data
Dec. 5, 2008 (DE) 10 2008 063 552.9

(51) Int. Cl. H01M 4/583; B05D 5/12; B82Y 99/00

(52) U.S. Cl. 252/502; 427/77; 977/742; 977/932

(57) ABSTRACT

A process for producing active material for an electrode of an electrochemical element includes providing carbon particles, applying a silicon precursor to surfaces of the carbon particles, and thermally decomposing the silicon precursor to form metallic silicon.

### RELATED APPLICATIONS

This is a §371 of International Application No. PCT/EP2009/008673, with an international filing date of Dec. 4, 2009 (WO 2010/063480 A1, published Jun. 10, 2010), which is based on German Patent Application No. 10 2008 063 552.9, filed Dec. 5, 2008, the subject matter of which is incorporated by reference.

### TECHNICAL FIELD

This disclosure relates to an active material for electrodes of an electrochemical element, a process for producing the active material, an electrode comprising such an active material and an electrochemical element comprising at least one such electrode.

### BACKGROUND

Rechargeable lithium batteries in which metallic lithium is used as the negative electrode material are known to have a very high energy density. However, it is also known that a whole series of problems can occur in the course of cycling (charging and discharging) of such batteries. For instance, unavoidable side reactions of metallic lithium with the electrolyte solution lead to coverage of the lithium surface with decomposition products which can influence the processes of lithium deposition and dissolution. In extreme cases, dendrites can also be formed, which under some circumstances can damage the electrode separator. The structure and composition of the surface layer formed by the side reactions on the metallic lithium, which is often also referred to as “solid electrolyte interface” (SEI), generally depend essentially on the solvent and on the conductive salt. The formation of such an SEI generally always results in an increase in the internal resistance of the battery, as a result of which charging and discharging processes can be greatly hindered.

For this reason, there has already been a prolonged search for active materials, especially for the negative electrodes of galvanic elements, in which the problems mentioned do not occur, but which allow the construction of batteries with acceptable energy densities.

The negative electrodes of currently available lithium ion batteries frequently have a negative electrode based on graphite. Graphite is capable of intercalating and also of desorbing lithium ions. The formation of dendrites is generally not observed. However, the ability of graphite to absorb lithium ions is limited. The energy density of batteries with such electrodes is therefore relatively limited.

A material which can intercalate comparatively large amounts of lithium ions is metallic silicon. With formation of the Li₂₂Si₅ phase, it is theoretically possible to absorb an amount of lithium ions which exceeds the comparable amount in the case of a graphite electrode by more than ten times. However, a problem is that the absorption of such a great amount of lithium ions can be associated with an exceptionally high change in volume (up to 300%), which in turn can have a very adverse effect on the mechanical integrity of electrodes with silicon as the active material.

To master this problem, the approach pursued in the past was to use very small silicon particles as active material (especially particles with a mean particle size well below 1 μm, i.e., nanoparticles). In the case of such small particles, the absolute changes in volume which occur are relatively small, and so the particles do not break up.

However, it has been found that the intermetallic phases formed in the lithiation of silicon have a similarly greatly reducing potential to metallic lithium. Therefore, the result here too is the formation of an SEI. Since the specific surface area of an active material which contains large amounts of nanoparticles is very large, the formation of the SEI consumes a correspondingly large amount of an electrolyte and lithium. As a result of this, the positive electrode in turn has to be oversized in principle, which results in a considerable fall in the energy density of a corresponding lithium ion cell and at least partly counterbalances the advantage of the high energy density of the negative electrode.

It could therefore be helpful to provide a novel, alternative electrode active material which enables the construction of batteries with relatively high energy density, but which at the same time has fewer disadvantages than the abovementioned known active materials.

### SUMMARY

We provide a process for producing active material for an electrode of an electrochemical element including providing carbon particles, applying a silicon precursor to surfaces of the carbon particles, and thermally decomposing the silicon precursor to form metallic silicon.

We also provide an electrochemical active material for a negative electrode of an electrochemical element produced by the process, including carbon particles whose surfaces are at least partly covered with a layer of silicon.

We further provide an electrode for an electrochemical element including the active material.

We still further provide an electrochemical element including at least one electrode.

### BRIEF DESCRIPTION OF THE DRAWINGS

FIG. 1 is a graph of a comparison of the cycling stability of an electrode including silicon-carbon composite particles with a comparable electrode including graphite as an active material as a function of charging and discharging cycles.

FIG. 2 is a graph of a comparison of the cycling stability of an electrode including silicon-carbon composite particles with a known comparable electrode already including a mixture of graphite and silicon nanoparticles as the active material.

### DETAILED DESCRIPTION

Our process can be used to obtain active materials which are outstandingly suitable for use in electrodes, especially in negative electrodes, of electrochemical elements. Preferred fields of application are in particular electrodes for rechargeable batteries with lithium ion and lithium polymer technology. The term “active material” shall generally be understood to mean a material which, in an electrochemical element, intervenes directly into the process of conversion of chemical to electrical energy. In the case of a lithium ion battery, it is possible, for example, for lithium ions to be intercalated into the active material of a negative electrode with absorption of electrons, and desorbed again with release of electrons.

The process thus comprises at least three steps, namely
(1) provision of carbon particles,
(2) application of a silicon precursor to the surface of the carbon particles and
(3) thermal decomposition of the silicon precursor to form metallic silicon.

The active material thus obtainable is thus a composite material based on carbon particles, on the surface of which metallic silicon has been deposited.

The carbon particles may especially be graphite particles, CNTs (carbon nanotubes) or mixtures of the two. The selection of the graphite particles is in principle unrestricted. For instance, it is possible in principle to use all graphite particles which can also be used in graphite electrodes known from the prior art. CNTs are known to be microscopically small tubular structures composed of carbon, into which lithium ions can likewise be intercalated. CNTs suitable for use as active materials are described, for example, in WO 2007/095013.

The term “silicon precursor” is in principle understood to mean any substance or any chemical compound which can be decomposed, especially by heating, to deposit metallic silicon. Such substances and compounds are known.

It is conceivable in principle to deposit the precursor from the gas phase onto the carbon particles. Particular preference is given, however, to applying a silicon precursor which is liquid or present in a liquid to the surface of the carbon particles, followed by the thermal de-composition mentioned. The silicon precursor may either be dissolved or dispersed in the liquid.

The silicon precursor can be applied to the surface of the carbon particles in various ways in principle. Which procedure is the most favorable here depends in principle on the nature of the precursor, which will be discussed in more detail later. In the simplest case, the carbon particles provided can be introduced, for example, into a solution in which the silicon precursor is present. The latter can then be deposited on the surface of the carbon particles. Any solvent present should be removed before the subsequent thermal decomposition.

The silicon precursor is more preferably at least one silane, most preferably an oligomeric or polymeric silane. More particularly, oligomeric or polymeric silanes which can be described by the general formula —[SiH₂]ₙ— where n≧10 are used, i.e., those which have a minimum chain length of at least 10 silicon atoms.

Such silanes are generally present in liquid form or can be processed in solution. There is thus no need to use any gaseous precursors. The corresponding apparatus complexity is correspondingly relatively low.

A silane mixture particularly suitable as a silicon precursor can be obtained, for example, by oligomerization or polymerization proceeding from cyclic silanes. Suitable cyclic silanes are those of the general formula SiₙH₂ₙ, especially where n≧3, more preferably where n=4 to 10. A particularly suitable starting material is especially cyclopentasilane. The oligomerization or the polymerization can especially be photoinduced. Irradiation induces ring opening, which can form chains of greater or lesser length. The formation of the chains itself proceeds inhomogeneously as in any polymerization. The result is thus a mixture of oligo- or polysilanes of different chain length. The mean molecular weight M_{w} of a silane mixture particularly preferred is especially between 500 and 5000.

The silicon precursor is generally decomposed by a heat treatment, especially at a temperature of >300° C. At such a temperature, oligomeric and polymeric silanes usually decompose to eliminate hydrogen. There is at least partial conversion to metallic silicon, especially to amorphous metallic silicon. Particular preference is given to selecting temperatures between 300° C. and 1200° C. For energetic reasons, the aim is typically to perform the conversion at very low temperatures. Especially temperatures between 300° C. and 600° C. are therefore preferred. At such temperatures, the oligo- or polysilane can be converted essentially completely.

Silanes or silane mixtures and suitable conditions for decomposition of such silanes and silane mixtures, are, incidentally, also specified in “Solution-processed silicon films and transistors” by Shimoda et al. (NATURE Vol. 440, Apr. 06, 2006, pages 783 to 786). Especially the corresponding experimental details in that publication are hereby fully incorporated by reference.

The active material producible by our process also forms part of our disclosure. In accordance with the above remarks, it comprises carbon particles, the surface of which is at least partly covered at least partly with a layer of silicon, especially a layer of amorphous silicon. More preferably, the active material consists of such particles.

Preferably, the layer of silicon on the surface of the carbon particles can form an essentially closed shell. The composite particles composed of carbon and silicon in this case have a core (formed by the carbon particle) and a shell of silicon arranged thereon.

On contact with water or air humidity, for example, in the course of production of an electrode paste (see the working example), the layer of silicon can be surface oxidized. The layer of silicon oxide which forms generally has a passivating effect. It counteracts oxidation of lower-lying silicon layers. The result is particles with a core of carbon, a middle layer of especially amorphous silicon and an outer layer of silicon oxide.

The conditions in the decomposition of the silicon precursor can be selected such that, in the layer or shell of silicon which forms, a small amount of hydrogen may still be present. In general, however, it is present in a proportion of below 5% by weight (based on the total weight of the layer or shell), preferably in a proportion between 0.001% and 5% by weight, especially in a proportion between 0.01 and 3% by weight.

The carbon particles preferably have a mean particle size between 1 μm and 200 μm, especially between 1 μm and 100 μm, especially between 10 μm and 30 μm.

The shell of silicon is typically not thicker than 15 μm. The result is that the total size of the particles (mean particle size) preferably does not exceed 215 μm, especially 115 μm. It is more preferably between 10 μm and 100 μm, especially between 15 μm and 50 μm.

It is preferred that the active material is essentially free of particles with particle sizes in the nanoscale range. More particularly, the active material preferably does not contain any carbon-silicon particles with sizes <1 μm.

The weight ratio of carbon to silicon in the active material is preferably in the range between 1:10 and 10:1. Particular preference is given here to values in the range between 1:1 and 3:1.

It has been found that, surprisingly, it is possible with the active material to produce electrodes having a lithium ion storage capacity one to three times higher than comparative electrodes with conventional graphite active material. The active material exhibited, in cycling tests, a similar cycling stability to the nanoparticulate silicon mentioned at the outset, but without having the disadvantages described.

Our electrode is characterized in that it has an active material. Typically, the active material in an electrode is incorporated into a binder matrix. Suitable materials for such a binder matrix are known. It is possible, for example, to use copolymers of PVDF-HFP (polyvinylidene difluoride-hexafluoropropylene). One possible alternative binder based on carboxymethylcellulose is disclosed in DE 10 2007 036 653.3.

The active material is present in an electrode typically in a proportion of at least 85% by weight. Further fractions are accounted for by the binder already mentioned and possibly by one or more conductivity additives (e.g., carbon black).

An electrochemical element is notable in that it has at least one electrode. An electrochemical element may, for example, be a stacked cell in which several electrodes and separators are arranged one on top of another in the manner of a stack. The fields of application for the active material and, hence, the electrodes are, however, unrestricted in principle, and so numerous other designs (for example, wound electrodes) are also conceivable.

Further features and advantages are evident from the description of the drawings which follows, and the working example. The individual features can each be implemented alone, or several can be implemented in combination with one another. The drawings and the working example serve merely for illustration and for better understanding and should in no way be interpreted in a restrictive manner.

### EXAMPLE

(1) To produce a preferred active material, cyclopentasilane was polymerized under an argon atmosphere (water content and oxygen content <1 ppm) with photoinduction by means of UV light at a wavelength of 405 nm. Polymerization was continued until the polysilane mixture obtained had a gel-like consistency. The latter was blended with graphite particles having a mean particle size of 15 μm to obtain a paste, which was subsequently heat-treated at a temperature of 823 K. The heat treatment was continued until no further evolution of hydrogen was observed. The material thus obtained was subsequently ground in a ball mill and adjusted to a mean particle size of approx. 20 μm.

(2) To produce a preferred electrode, 8% by weight of sodium carboxymethylcellulose (Walocell® CRT2000PPA12) was introduced into water and swelled fully. In addition, 87% of the active material produced according to (1) and 5% of conductive black (Super P) as a conductivity improver were introduced and dispersed successively.

The electrode paste thus obtained was knife-coated onto a copper foil in a thickness of 200 μm.

(3) To produce a comparative electrode, 8% by weight of sodium carboxymethylcellulose (Walocell® CRT2000PPA12) was introduced into water and swelled fully. In addition, 20% nanoparticulate silicon (Nanostructured and Amorphous Materials, Los Alamos) and 5% carbon nanofibers (Electrovac AG, LHT-XT) were successively introduced and dispersed with high energy. 5% conductive black (Super P) and 62% graphite (natural graphite, potato shaped) were finally introduced and dispersed.

The electrode paste thus obtained was knife-coated onto a copper foil in a thickness of 200 μm.

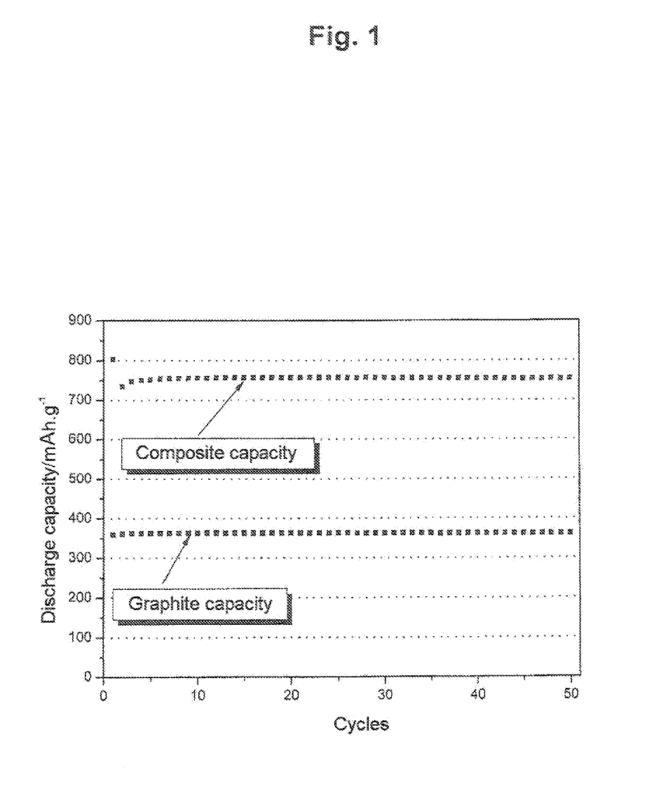

FIG. 1 shows a comparison of the cycling stability of our electrode produced according to (2) with a comparable electrode comprising graphite as the active material (in place of the silicon-carbon composite particles) as a function of charging and discharging cycles. It is clearly evident that our electrode has a much higher capacity.

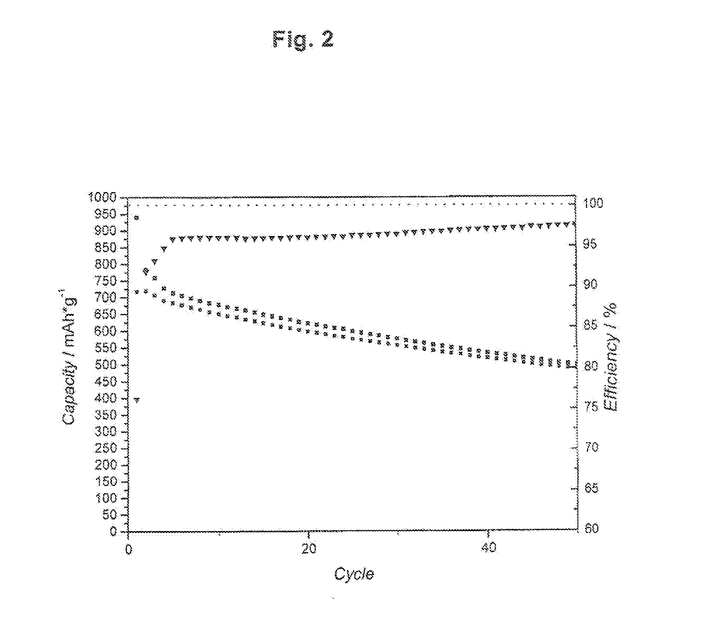

FIG. 2 shows a comparison of our electrode which comprises silicon-carbon composite particles and was produced according to (2) with a comparative electrode produced according to (3) as a function of charging and discharging cycles. In the case of our electrode (upper curve, triangles), the capacity remains essentially constant even after more than 40 cycles. In the case of the comparative electrode (lower curve, squares), in contrast, a distinct fall in capacity is measurable.

1-15. (canceled)

16. A process for producing active material for an electrode of an electrochemical element comprising:
providing carbon particles,
applying a silicon precursor to surfaces of the carbon particles, and
thermally decomposing the silicon precursor to form metallic silicon.

17. The process as claimed in claim 16, wherein the silicon precursor is a liquid or is present in a liquid.

18. The process as claimed in claim 16, wherein the carbon particles, are at least one member selected from the group consisting of graphite particles, CNTs (carbon nanotubes) and mixtures of graphite particles and CNTs.

19. The process as claimed in claim 16, wherein the, silicon precursor comprises at least one silane.

20. The process as claimed in claim 16, wherein the silicon precursor comprises an oligomeric or polymeric silane.

21. The process as claimed in claim 16, wherein the silicon precursor comprises an oligomeric or polymeric silane of the general formula —[SiH₂]ₙ— with n≧10.

22. The process as claimed in claim 16, the silicon precursor is a silane mixture prepared by photoinduced oligomerization or polymerization proceeding from a cyclic silane.

23. The process as claimed in claim 22, wherein the cyclic silane is cyclopentasilane.

24. The process as claimed in claim 22, wherein the mean molecular weight M_{w} of the silane mixture is 500 to 5000.

25. The process as claimed in claim 16, wherein the decomposition of the silicon precursor is performed at a temperature >300° C.

26. The process as claimed in claim 16, wherein decomposition of the silicon precursor is performed at a temperature of 300° C. to 1200° C.

27. The process as claimed in claim 16, wherein decomposition of the silicon precursor is performed at a temperature of 300° C. to 600° C.

28. An electrochemical active material for a negative electrode of an electrochemical element produced by the process of claim 16, comprising carbon particles whose surfaces are at least partly covered with a layer of silicon.

29. The active material as claimed in claim 28, wherein the carbon particles have surfaces at least partly covered with a layer of amorphous silicon.

30. The active material as claimed in claim 28, wherein the carbon particles comprise a core of carbon and an essentially closed, shell of silicon.

31. The active material as claimed in claim 30, wherein the shell of silicon contains 0.001% by weight and 5% by weight of hydrogen.

32. The active material as claimed in claim 31, wherein the shell of silicon contains 0.001 and 3% by weight of hydrogen.

33. The active material as claimed in claim 28, wherein the carbon particles have a mean particle size of 1 μm to 200 μm.

34. The active material as claimed in claim 28, wherein the carbon particles with the layer of silicon on the surface have a mean particle size of 10 μm to 215 μm.

35. The active material as claimed in claim 28, having a weight ratio of carbon to silicon of 1:10 to 10:1.

36. The active material as claimed in claim 28, having a weight ratio of carbon to silicon of 1:1 to 3:1.

37. An electrode for an electrochemical element comprising an active material as claimed in claim 28.

38. The electrode as claimed in claim 37, wherein the active material is incorporated into a binder matrix.

39. An electrochemical element comprising at least one electrode as claimed in claim 37.
